(19) United States
(12) Patent Application Publication
(10) Pub. No.: US 2016/0332614 A1
(43) Pub. Date: Nov. 17, 2016

(54) HYBRID VEHICLE

(71) Applicant: TOYOTA JIDOSHA KABUSHIKI KAISHA, Toyota-shi (JP)

(72) Inventor: Hiroyuki OGURA, Toyota-shi (JP)

(73) Assignee: TOYOTA JIDOSHA KABUSHIKI KAISHA, Toyota-shi (JP)

(21) Appl. No.: 15/151,603

(22) Filed: May 11, 2016

(30) Foreign Application Priority Data
May 15, 2015 (JP) 2015-099886

(51) Int. Cl. B60W 20/00; B60K 6/383; B60K 6/26; B60K 6/442; B60K 6/365

(52) U.S. Cl. CPC B60W 20/00; B60K 6/442; B60K 6/365; B60K 6/26; B60K 6/383; Y10S 903/93; Y10S 903/91; B60Y 2200/92; B60Y 2300/42; B60Y 2300/43; B60Y 2300/60; Y10S 903/913; B60Y 2400/427; B60Y 2400/73; B60Y 2300/184; B60Y 2306/03; B60Y 2306/09

(57) ABSTRACT

When the drive mode of a hybrid vehicle is a dual motor drive mode, a counter C is incremented by value 1. When the drive mode is not the dual motor drive mode, the counter C is reset to value 0. When the counter C becomes equal to or higher than a reference value Cref1, a lubrication measure flag F is set to value 1. Setting the lubrication measure flag F to the value 1 causes a carrier of a planetary gear to be rotated and causes pinion gears to revolve around the carrier. In the dual motor drive mode, the hybrid vehicle is driven with stooping rotation of the carrier of the planet airy gear. This is likely to cause a shortage of lubricant oil at a pinion gear that rotates revolution at the upper position in the planetary gear. The control of rotating the carrier and thereby revolving the pinion gears around the carrier changes the position of the pinion gear from the upper position to the lower position and thereby reduces the shortage of lubricant oil.

This application claims priority to Japanese Patent. Application No. 2015-99886 filed 15 May, 2015, the contents of which is incorporated herein by reference.

### TECHNICAL FIELD

The present invention relates to a hybrid vehicle and more specifically relates to a hybrid vehicle equipped with an engine, a first motor, a second motor and a planetary gear mechanism.

### BACKGROUND ART

In a proposed configuration of a hybrid vehicle, a carrier of a planetary gear mechanism is connected with an output shaft of an engine, a sun gear is connected with a rotating shaft of a first motor, and a ring gear is connected with a driveshaft which is linked with an axle and which a second motor is mounted to. A one-way clutch is mounted to the carrier to control rotation of the carrier in a reverse direction of the engine (for example, Patent Literature 1). The hybrid vehicle of this configuration may be driven in a dual motor drive mode that causes power from the first motor to be output to the driveshaft via pinion gears and the ring gear by rotation control of the one-way clutch and causes power from the second motor to be output to the driveshaft, while stopping operation of the engine.

### CITATION LIST

### Patent Literature

PTL 1: JP 2012-224148A

### SUMMARY OF INVENTION

### Technical Problem

When the hybrid vehicle of the above configuration is driven in the dual motor drive mode, however, there is a possibility that lubricant oil is short at the pinion gears in the planetary gear mechanism. In the dual motor drive mode, a torque for negative rotation is output from the first motor to the carrier of the planetary gear mechanism in the state that the engine stops operation. The one-way clutch controls rotation of the carrier to stop rotation of the carrier. It is often the case that the lubricant oil is supplied to the pinion gears in the planetary gear mechanism by rotation of the carrier. Stopping rotation of the carrier thus leads to a shortage of the lubricant oil supplied to the pinion gears. Additionally, the lubricant oil flows down by the gravity, so that the lubricant oil is short especially at the pinion gear that stops revolution at the upper position in the planetary gear mechanism s The shortage of the lubricant oil supplied to the pinion gear is likely to cause problems, such as deterioration of power transmission and the occurrence of abnormal noise.

With regard to the hybrid vehicle, an object of the invention is to reduce a shortage of lubricant oil supplied to pinion gears in a dual motor drive mode.

### Solution to Problem

In order to achieve the object described above, the hybrid vehicle of the invention may be implemented by the following aspects.

According to one aspect of the invention, there is provided a hybrid vehicle including: an engine; a first motor that is configured to generate electric power; a planetary gear mechanism having a sun gear, a ring gear, a plurality of pinion gears that engage with, the sun gear and with the ring gear, and a carrier that is linked with the plurality of pinion gears, wherein the sun gear, the ring gear and the carrier are respectively connected in this sequence with a rotating shaft of the first motor, a drive shaft linked with an axle and an output shaft of the engine; a second motor that is configured to generate electric power and is mounted to the drive shaft; a battery that is configured to transmit electric power to and from the first motor and, the second motor; a rotation control mechanism that is configured to control rotation of the carrier; and a controller that is configured, to control the engine, the first motor and the second motor such as to cause the hybrid vehicle to be driven in one of a plurality of drive modes, wherein the plurality of drive modes include a dual motor drive mode that causes the hybrid vehicle to be driven with powers from the first motor and the second motor with stopping rotation of the carrier and a hybrid drive mode that causes the hybrid vehicle to be driven with powers from the engine, the first motor and the second motor with rotating the carrier, wherein after a stop of rotation of the carrier during a drive of the hybrid vehicle in the dual motor drive mode, when a predetermined condition including a time elapsed since the stop of rotation is satisfied, the controller performs a predetermined rotation control that controls the carrier to rotate.

After a stop of rotation of the carrier that is connected with the output shaft of the engine during a drive of the hybrid vehicle in the dual motor drive mode, when the predetermined condition including the time elapsed since the stop of rotation is satisfied, the hybrid vehicle of the invention performs the predetermined rotation control that controls the carrier to rotate. As the carrier rotates, the pinion gears that have stopped revolution start revolving according to the rotation angle of the carrier. Rotating the carrier can thus change the position of the pinion gear that stops revolution at the upper position in the planetary gear mechanism. As described above, the lubricant oil is short especially at the pinion gear that stops revolution at the upper position in the planetary gear mechanism. The control of rotating the carrier and thereby revolving the pinion gears around the carrier accordingly reduces the shortage of the. lubricant oil supplied to the pinion gears. The “predetermined condition including the time elapsed since the stop of rotation” means that the predetermined condition including a condition that a certain time period has elapsed since a stop of rotation of the carrier. A condition caused at the time of stopping rotation of the carrier and a condition caused immediately after a stop of rotation of the carrier are excluded from the “predetermined condition”.

The rotation control mechanism may be, for example, a one-way clutch that allows for rotation of the carrier only in a direction of normal rotation of the engine or may be a brake that fixes the carrier to be non-rotatable and releases fixation to be rotatable. In an application that uses the one-way clutch as the rotation control mechanism, the predetermined rotation control may be a control of rotating the carrier in a normal direction of the engine. In an application that uses the brake as the rotation control mechanism, the dual motor drive mode is activated after the brake is ON. The predetermined rotation control may thus include a control of setting the brake OFF at the start of rotation of the carrier and setting the brake ON at the stop of rotation of the carrier. In the application that uses the brake as the rotation control mechanism, when the engine is allowed to be rotated in a reverse direction, the rotating direction of the carrier may be a direction of normal rotation of the engine or may be a direction of reverse rotation of the engine.

The rotation angle of the carrier is preferably 180 degrees to rotate the pinion gear that stops revolution at the upper position in the planetary gear mechanism to the lower position. In the planetary gear mechanism using three pinion gears, the carrier may be rotated by 120 degrees each time. In the planetary gear mechanism using four pinion gears, the carrier may be rotated by 90 degrees each time. This configuration sequentially changes the positions of the pinion gears that stop revolution in the planetary gear mechanism, thus reducing the shortage of lubricant oil supplied to the pinion gears.

### BRIEF DESCRIPTION OF DRAWINGS

FIG. 1 is a configuration diagram illustrating the schematic configuration of a hybrid vehicle according to one embodiment of the invention;

FIG. 2 is a flowchart showing one example of a dual motor drive control routine performed by an HVECU;

FIG. 3 is a flowchart showing one example of a flag setting routine performed by the HVECU;

FIG. 4 is a diagram illustrating rotation of a carrier when an accelerator pedal is changed from ON to OFF;

FIG. 5 is a diagram illustrating rotation of the carrier when the accelerator pedal is depressed by a predetermined amount or more;

FIG. 6 is a flowchart showing another example of the dual motor drive control routine according to a modification;

FIG. 7 is a flowchart showing another example of the flag setting routine according to a modification;

FIG. 8 is a flowchart showing another example of the flag setting routine according to another modification;

FIG. 9 is a configuration diagram illustrating the schematic configuration of a hybrid vehicle according to a modification; and

FIG. 10 is a configuration diagram illustrating the schematic configuration of a hybrid vehicle according to another modification.

### DESCRIPTION OF EMBODIMENTS

The following describes some aspects of the invention with reference to an embodiment.

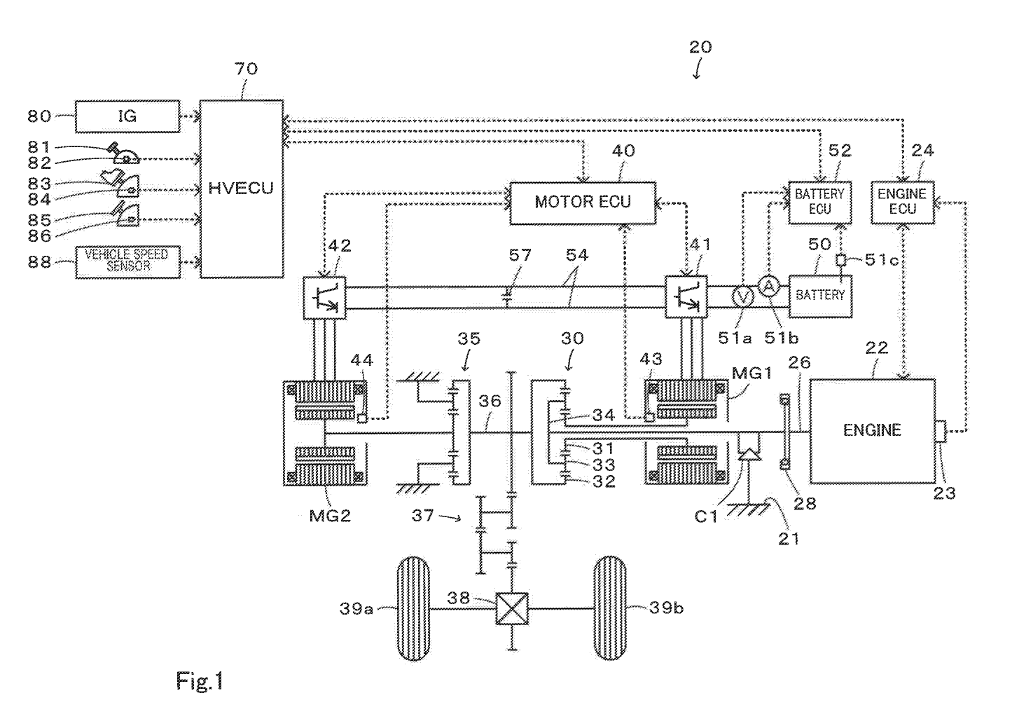

FIG. 1 is a configuration diagram illustrating the schematic configuration of a hybrid vehicle 20 according to one embodiment of the invention.

As shown in FIG. 1, the hybrid vehicle 20 of the embodiment includes an engine 22, a planetary gear 30, a one-way clutch C1, motors MG1 and MG2, inverters 41 and 42, a battery 50 and a hybrid electronic control unit (hereinafter referred to as “HVECU”) 70.

The engine 22 is configured as an internal combustion engine that uses, for example, gasoline or light oil as fuel to output power. The engine 22 is operated and controlled by an engine electronic control unit (hereinafter referred to as “engine ECU”) 24.

The engine ECU 24 is implemented by a CPU-based microprocessor and includes a ROM that, stores processing programs, a RAM that temporarily stores data, input and output ports and a communication port other than the CPU, although not being illustrated.

The engine ECU 24 inputs, via its input port, signals from various sensors required for operation control of the engine 22. Examples of the signals from various sensors include:
crank angle θcr from a crank position sensor 23 configured to detect the rotational position of a crankshaft 26 of the engine 22; and
throttle position TH from a throttle valve position sensor configured to detect the position of a throttle valve.

The engine ECU 24 outputs, via its output port, various control signals for operation control of the engine 22. Examples of the various control signals include:
drive control signal to a throttle motor configured to adjust the position of the throttle valve;
drive control signal to a fuel injection valve; and
drive control signals to an ignition coil integrated with an igniter.

The engine ECU 24 is connected with the HVECU 70 via the respective communication ports. The engine ECU 24 operates and controls the engine 22 in response to control signals from the HVECU 70. The engine ECU 24 also outputs data regarding the operating conditions of the engine 22 to the HVECU 70 as appropriate. The engine ECU 24 computes an angular velocity and a rotation speed of the crank shaft 26 or in other words, an angular velocity ωne and a rotation speed Ne of the engine 22, based on the crank angle θcr from the crank position, sensor 23.

The planetary gear 30 is configured as a single pinion-type planetary gear mechanism including a sun gear 31 as an external gear, a ring gear 32 as an internal gear, a plurality of pinion gears 33 that engage with the sun gear 31 and the ring gear 32 and a carrier 34 that holds the plurality of pinion gears 33 to rotate on their axes and revolve around the carrier 34. The sun gear 31 is connected with a rotor of the motor MG1. The ring gear 32 is connected with a driveshaft 36 that is linked with drive wheels 39a and 39b via a differential gear 38 and a gear mechanism 37. The carrier 34 is connected with the crankshaft 26 of the engine 22 via a damper 28. A lubricant oil is supplied to the planetary gear 30 by an oil pump (not shown) and is supplied to the pinion gears 33 by, for example, rotation of the carrier 34.

The one-way clutch C1 is attached to the carrier 34 and to a casing 21 fixed to the vehicle body. The one-way clutch C1 allows the carrier 34 to rotate relative to the casing 21 only in a direction of normal rotation of the engine 22.

The motor MG1 is configured, for example, as a synchronous motor generator. The motor MG1 has the rotor that is connected with the sun gear of the planetary gear 30 as described above. The motor MG2 is configured, for example, as a synchronous motor generator. The motor MG2 has a rotor that is connected with the driveshaft 36 via a reduction gear 35. The inverters 41 and 42, along with the battery 50, are connected with power lines 54. A smoothing capacitor 57 is attached to the power lines 54. The motors MG1 and MG2 are rotated and driven by switching control of a plurality of switching elements (not shown) of the inverters 41 and 42 by a motor electronic control unit (hereinafter referred to as “motor ECU”) 40.

The motor ECU 40 is implemented by a CPU-based microprocessor and includes a ROM that stores processing programs, a RAM that temporarily stores data, input and output ports and a communication port other than the CPU, although not being illustrated.

The motor ECU 40 inputs, via its input port, signals from various sensors required for drive control of the motors MG1 and MG2. Examples of the signals from various sensors include:
rotational positions θm1 and θm2 from rotational position detection sensors 43 and 44 configured to detect the rotational positions of the rotors of the motors MG1 and MG2; and
phase currents from current sensors configured to detect electric currents flowing through the respective phases of the motors MG1 and MG2.

The motor ECU 40 outputs, via its output port, for example, switching control signals to the switching elements (not shown) of the inverters 41 and 42.

The motor ECU 40 is connected with the HVECU 70 via the respective communication ports. The motor ECU 40 drives and controls the motors MG1 and MG2, in response to control signals from the HVECU 70. The motor ECU 40 also outputs data regarding the driving conditions of the motors MG1 and MG2 to the HVECU 70 as appropriate. The motor ECU 40 computes rotation speeds Nm1 and Nm2 of the motors MG1 and MG2, based on the rotational positions θm1 and θm2 of the rotors of the motors MG1 and MG2 from the rotational position detection sensors 43 and 44.

The battery 50 is configured, for example, as a lithium ion secondary battery or a nickel metal hydride secondary battery. The battery 50, along with the inverters 41 and 42, is connected with the power lines 54 as described above. The battery 50 is under management, of a battery electronic control unit (hereinafter referred to as “battery ECU”) 52.

The battery ECU 52 is implemented by a CPU-based microprocessor and includes a ROM that stores processing programs, a RAM that temporarily stores data, input and output ports and a communication port other than the CPU, although not being illustrated.

The battery ECU 52 inputs, via its input port, signals from various sensors required for management of the battery 50. Examples of the signals from various sensors include:
battery voltage Vb from a voltage sensor 51a placed between terminals of the battery 50;
battery current Ib from a current sensor 51b mounted to an output terminal of the battery 50 (providing a positive value when the battery 50 is discharged); and
battery temperature Tb from a temperature sensor 51c mounted to the battery 50.

The battery ECU 52 is connected with the HVECU 70 via the respective communication ports. The battery ECU 52 outputs data regarding the conditions of the battery 50 to the HVECU 70 as appropriate. The battery ECU 52 computes a charge-discharge electric power Pb as the product of the battery voltage Vb from the voltage sensor 51a and the battery current Ib from the current sensor 51b. The battery ECU 52 also computes a state of charge SOC, based on an integrated value of the battery current Ib from the current sensor 51b. The state of charge SOC denotes a ratio of power capacity dischargeable from the battery 50 to the entire capacity of the battery 50.

The HVECU 70 is implemented by a CPU-based microprocessor and includes a ROM that stores processing programs, a RAM that temporarily stores data, input and output ports and a communication port other than the CPU, although not being illustrated.

The HVECU 70 inputs, via its input port, signals from various sensors. Examples of the signals from various sensors include:
ignition signal from an ignition switch 80;
shift position SP from a shift position sensor 82 configured to detect the operational position of a shift lever 81;
accelerator position Acc from an accelerator pedal position sensor 84 configured to detect the depression amount of an accelerator pedal 83;
brake pedal position BP from a brake pedal position sensor 86 configured to detect the depression amount of a brake pedal 85; and
vehicle speed V from a vehicle speed sensor 88.

The HVECU 70 is connected with the engine ECU 24, the motor ECU 40 and the battery ECU 52 via the communication ports as described above. The HVECU 70 transmits various control signals and data to and from the engine ECU 24, the motor ECU 40 and the battery ECU 52.

The hybrid vehicle 20 of the embodiment having the above configuration runs in a hybrid drive mode (HV drive mode) or in an electric drive mode (EV drive mode). The HV drive mode denotes a drive mode in which the hybrid vehicle 20 is driven using the powers from the engine 22, the motor MG1 and the motor MG2. The EV drive mode denotes a drive mode in which the hybrid vehicle 20 is driven using the powers from at least the motor MG1 and the motor MG2 with stopping operation of the engine 22. The EV drive mode includes a single motor drive mode in which the hybrid vehicle 20 is driven with only a torque from the motor MG2 while no torque is output from the motor MG1 and a dual motor drive mode in which the hybrid vehicle 20 is driven with both a torque from the motor MG1 and a torque from the motor MG2.

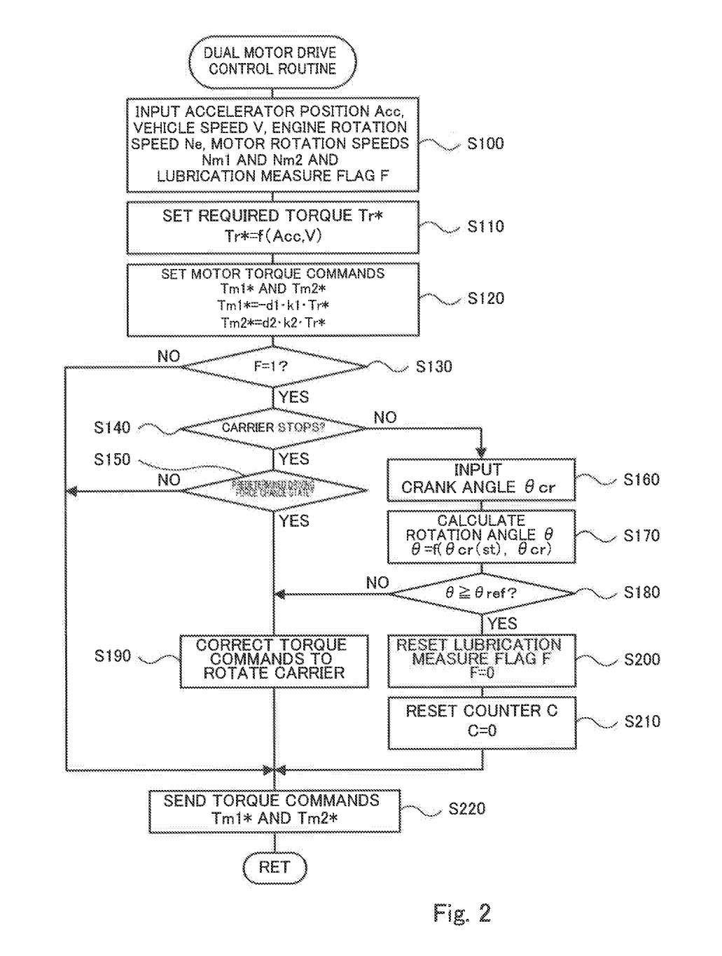

The following describes the operations of the hybrid vehicle 20 of the embodiment having the above configuration or more specifically a series of operations to take a measure against a shortage of lubricant oil supplied to the pinion gears 33 of the planetary gear 30 during a drive in the dual motor drive mode. FIG. 2 is a flowchart showing one example of a dual motor drive control routine performed by the HVECU 70 of the embodiment. FIG. 3 is a flowchart, showing one example of a flag setting routine to set a lubrication measure flag F used in the dual motor drive control routine. The routine of FIG. 2 is repeatedly performed when the drive mode is the dual motor drive mode. The routine of FIG. 3 is repeatedly performed at predetermined time intervals (for example, every several msec). For the convenience of explanation, the following sequentially describes the procedure of setting the lubrication measure flag F with reference to the flag setting routine of FIG. 3 and the dual motor drive control with reference to the dual motor drive control routine of FIG. 2.

When the flag setting routine of FIG. 3 is triggered, the HVECU 70 fist inputs the drive mode (step S300) and determines whether the input drive mode is the dual motor drive mode (step S310). When the input drive mode is the dual motor drive mode, the HVECU 70 increments a counter C by adding value 1 to the counter C (step S320). When the input drive mode is not the dual motor drive mode, on the other hand, the HVECU 70 resets the counter C to value 0 (step S330).

The HVECU 70 subsequently determines whether the counter C is equal to or higher than a reference value Cref1 (step S340). The reference value Cref1 denotes a threshold value to determine whether a predetermined time period Tref1 has elapsed since a stop of rotation of the carrier 34 and is determined, based on the predetermined time period Tref1 and the interval of execution of this flag setting routine. In the dual motor drive mode, rotation of the carrier 34 is stopped as described above. The lubricant oil is supplied to the pinion gears 33, for example, by rotation of the carrier 34. Stopping rotation of the carrier 34 results in a shortage of the lubricant oil supplied to the pinion gears 33. The lubricant oil flows down by the gravity and thus becomes short especially at the pinion gear that stops revolution at the upper position. The shortage of the lubricant oil supplied to the pinion gears 33 is likely to cause problems, such as deterioration of the transmission efficiency of the power output from the motor MG1 to the driveshaft 36 and the occurrence of abnormal noise. There is accordingly a need to take a measure to supply the lubricant oil to the pinion gears 33. The predetermined time period Tref1 is determined in advance by experiment or by analysis as a time duration that does not cause such problems in the case where stopping rotation of the carrier 34 continues, and may be, for example, 80 sec. 100 sec or 120 sec. The processing of step S340 accordingly determines whether there is a need to take a measure against a shortage of the lubricant oil supplied to the pinion gears 33.

When it is determined at step S340 that the counter C is lower than the reference value Cref1, the HVECU 70 determines that no measure is required for a shortage of the lubricant oil supplied to the pinion gears 33, keeps the lubrication measure flag F at its initial value (value 0) and terminates the flag setting routine. When it is determined at step S340 that the counter C is equal to or higher than the reference value Cref1, on the other hand, the HVECU 70 determines that a measure is required for a shortage of the lubricant oil supplied to the pinion gears 33, sets the lubrication measure flag F to value 1 (step S350) and terminates the flag setting routine. The lubrication measure flag F is set to the value 0 when there is no need to take a measure against a shortage of the lubricant oil supplied to the pinion gears 33, while being set to the value 1 when there is a need to take a measure against a shortage of the lubricant oil supplied to the pinion gears 33.

The dual motor drive control is described with reference to the dual motor drive control routine of FIG. 2. When the dual motor drive control routine is triggered, the HVECU 70 first inputs data required for control, for example, the accelerator position Acc from the accelerator pedal position sensor 84, the vehicle speed V from the vehicle speed sensor 88, the rotation speed Ne of the engine 22, the rotation speeds Nm1 and Nm2 of the motors MG1 and MG2 and the lubrication measure flag F (step S100). The rotation speed Ne of the engine 22 is computed based on the crank angle θcr of the engine 22 from the crank position sensor 23 and is input from the engine ECU 24 by communication. The rotation speeds Nm1 and Nm2 of the motors MG1 and MG2 are computed based on the rotational positions of the rotors of the motors MG1 and MG2 from the rotational position detection sensors 43 and 44 and are input from the motor ECU 40 by communication.

After inputting the data, the HVECU 70 sets a required torque Tr*, based on the input accelerator position Acc and the input, vehicle speed V (step S110). The HVECU 70 subsequently sets the result of multiplication of the required torque Tr* by a torque distribution, ratio d1, a conversion factor k1 and a value (−1) to a torque command Tm1* of the motor MG1, while setting the result of multiplication of the required torque Tr* by a torque distribution ratio d2 and a conversion factor k2 to a torque command Tm2* of the motor MG2 (step S120). The torque distribution ratios d1 and d2 denote ratios of the torque output from the motor MG1 and the torque output from the motor MG2 to the required torque Tr*. In the single motor drive mode, the torque distribution ratio d1 is equal to value 0. The conversion factor k1 denotes a coefficient used to convert the rotation speed of the driveshaft 36 to the rotation speed Nm1 of the motor MG1 in the state that the carrier 34 stops rotation. The conversion factor k2 denotes a coefficient used to convert the rotation speed of the driveshaft 36 to the rotation speed Nm2 of the motor MG2 and corresponds to the gear ratio of the reduction gear 35.

After setting the torque commands Tm1* and Tm2* of the motors MG1 and MG2, the HVECU 70 determines whether the lubrication measure flag F is the value 1 (step S130). When the lubrication measure flag F is the value 0, i.e., when there is no need to take a measure against a shortage of the lubricant oil supplied to the pinion gears 33, the HVECU 70 sends the set torque commands Tm1* and Tm2* to the motor ECU 40 (step S220) and terminates this routine. When receiving the torque commands Tm1* and Tm2*, the motor ECU 40 performs switching control of the switching elements of the inverters 41 and 42 to drive the motors MG1 and MG2 with the torque commands Tm1* and Tm2*. This control causes the hybrid vehicle 20 to be driven with the powers from the motor MG1 and the motor MG2 while stopping; rotation of the carrier 34.

When it is determined at step S130 that the lubrication measure flag F is the value 1, on the other hand, the HVECU 70 determines that there is a need to take a measure against a shortage of the lubricant oil supplied to the pinion gears 33 and subsequently determines whether the carrier 34 stops rotation (step S140). It is determined that the carrier 34 stops rotation when the rotation speed Ne of the engine 22 is equal to value 0. According to this embodiment, a measure taken against, a shortage of the lubricant oil supplied to the pinion gears 33 rotates the carrier 34 and thereby revolves the pinion gears 33 around the carrier 34 as described later. The processing of step S140 determines whether the measure is being implemented against a shortage of the lubricant oil.

When it is determined at step S140 that, the carrier 34 stops rotation, i.e., when the measure is not being implemented against a shortage of the lubricant oil supplied to the pinion gears 33 (step S140), the HVECU 70 subsequently determines whether the vehicle, falls into a predetermined driving force change state (step S150). The predetermined driving force change state may be, for example, a state that the driving state of the vehicle is changed relatively abruptly such as a state that the accelerator pedal 83 is changed from ON to OFF or a state that the accelerator pedal 83 is depressed by a predetermined amount or more, or a state that the vehicle runs on a downhill in an accelerator-off condition. Rotation of the carrier 34 is likely to cause the driver and the passengers to feel strange toy a torque variation. Such a feeling of strangeness is more likely to be provided when the driving state of the vehicle is relatively stable, compared with when the driving state of the vehicle is abruptly changed. The processing of step S140 accordingly determines whether the driver and the passengers are likely to have a feeling of strangeness.

When it is determined at step S150 that the vehicle does not fall into the predetermined driving force change state, the HVECU 70 recognizes that the driving state of the vehicle is relatively stable and is likely to cause the driver and the passengers to feel strange, by a torque variation and thereby determines that a measure is not to be taken against a shortage of the lubricant oil supplied to the pinion gears 33. The HVECU 70 accordingly sends the set torque commands Tm1* and Tm2* to the motor ECU 40 (step S220) and terminates this routine.

When it is determined at step S150 that the vehicle falls into the predetermined driving force change state, on the other hand, the HVECU 70 recognizes that the driving state of the vehicle is abruptly changed and thereby determines that a measure is allowed to be taken against a shortage of the lubricant oil supplied to the pinion gears 33. The HVECU 70 accordingly corrects the torque commands Tm1* and Tm2* of the motors MG1 and MG2 to rotate the carrier 34 in the direction of normal rotation of the engine 22 (step S190), sends the corrected torque commands Tm1* and Tm2* of the motors MG1 and MG2 to the motor ECU 40 (step S220) and terminates the dual motor drive control routine. When the predetermined driving force change state is the state that the accelerator pedal 83 is changed from ON to OFF, it is often the case that the torque command Tm1* of the motor MG1 is set to value 0 and the torque command Tm2* of the motor MG2 is set to a torque that provides a slight deceleration force. Accordingly, the HVECU 70 performs correction to set the torque command Tm1* of the motor MG1 to a torque, required for normal rotation of the engine 22. This causes the carrier 34 to be rotated in the direction of normal rotation of the engine 22. When the predetermined driving force change state is the state that the accelerator pedal 83 is depressed by a predetermined amount or more, acceleration is required, so that it is often the case that, the rotation speed Nm2 of the motor MG2 increases with an increase of the vehicle speed V. Accordingly, the HVECU 70 corrects the torque command Tm1* of the motor MG1 to maintain the rotation speed Nm1 of the motor MG1, and corrects the. torque command Tm2* of the motor MG2 to output the required torque. Tr* to the driveshaft 36 while increasing the rotation speed Nm2 of the motor MG2. This causes the carrier 34 to be rotated in the direction of normal rotation of the engine 22. When the predetermined driving force change state is the state that the vehicle runs on a downhill in the accelerator-off condition, it is often the case that the vehicle speed V increases by inertia and the rotation speed Nm2 of the motor MG2 increases. Accordingly, the HVECU 70 corrects the torque command Tm1* of the motor MG1 to maintain the rotation speed Nm1 of the motor MG1 and corrects the torque command Tm2* of the motor MG2 to output the required torque Tr* to the driveshaft 36 while increasing the rotation speed Nm2 of the motor MG2. This causes the carrier 34 to be rotated by inertia in the direction of normal rotation of the engine 22.

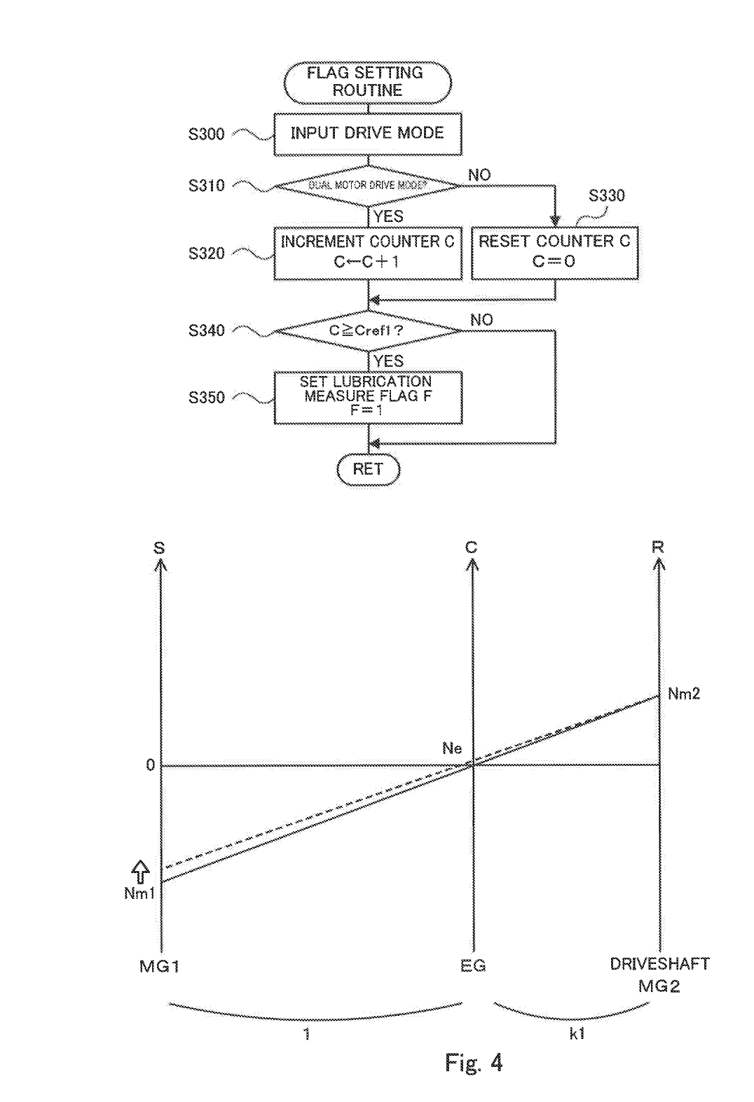

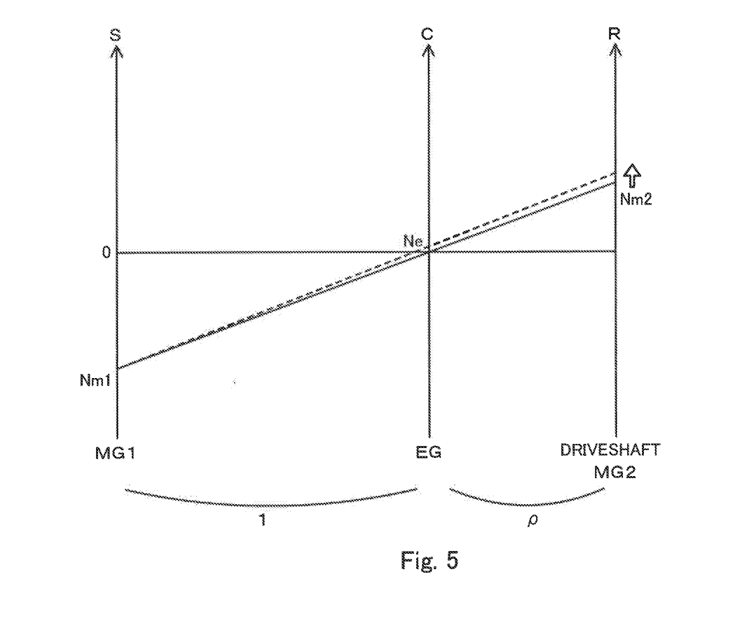

FIG. 4 is a collinear diagram illustrating the case where the carrier 34 is rotated when the accelerator pedal 83 is changed from ON to OFF. FIG. 5 is a collinear diagram illustrating the case where the carrier 34 is rotated when the accelerator pedal 83 is depressed, by a predetermined amount or more. In the diagram, axis S on the left side shows the rotation speed of the sun gear 31 that is equal to the rotation speed Nm1 of the motor MG1; axis C shows the rotation speed of the carrier 34 that is equal to the rotation speed Ne of the engine 22; and axis R shows the rotation speed Nr of the ring gear 32 that is equal to the division of the rotation speed Nm2 of the motor MG2 by a gear ratio k2 of the reduction gear 35. A solid line shows the state before the carrier 34 is rotated, and a broken line shows the state that the carrier 34 is being rotated. As shown in FIG. 4, the correction of changing the rotation speed Nm1 of the motor MG1 in the direction of normal rotation of the engine 22 when the accelerator pedal 83 is changed from ON to OFF causes the carrier 34 to be rotated in the direction of normal rotation of the engine 22. As shown in FIG. 5, the correction of maintaining the rotation speed Nm1 of the motor MG1 and increasing the rotation speed Nm2 of the motor MG2 with an increase of the vehicle speed V when the accelerator pedal 83 is depressed by a predetermined amount or more causes the carrier 34 to be rotated in the direction of normal rotation of the engine 22. A collinear diagram in the case where the carrier 34 is rotated when the predetermined driving force change state is the state that, the vehicle runs on a downhill in the accelerator-off condition is similar to the collinear diagram of FIG. 5.

In the case where the carrier 34 is rotated as described above, it is determined at step S140 that the carrier 34 is rotated, i.e., it is determined that the measure is being implemented against a shortage of the lubricant oil, in a next cycle of the dual motor drive control routine. In this case, the HVECU 70 inputs the crank angle θcr of the engine 22 (step S160) and calculates a rotation angle θ of the carrier 34 by subtracting a crank angle θcr(st) when the carrier 34 stops rotation from the input crank angle θcr (step S170). The crank angle θcr is detected by the crank position, sensor 23 and is input from the engine ECU 24 by communication.

The HVECU 70 subsequently determines whether the rotation angle θ reaches a reference value θref (step S180). The reference value θref is 180 degrees according to this embodiment, since it is preferable to revolve the pinion gear 33 that is located at the upper position when the carrier 34 stops rotation, to the lower position. The reference value θref may be a value, of sequentially changing the positions of the pinion gears 33. The reference value θref may be 120 degrees for the planetary gear 30 including three pinion gears 33 and maybe 90 degrees for the planetary gear 30 including four pinion gears 33.

When it is determined at step S180 that the rotation angle θ does not reach the reference value θref, the HVECU 70 determines that there is a need to continue rotation of the carrier 34. The HVECU 70 accordingly corrects the torque commands Tm1* and Tm2* of the motors MG1 and MG2 to rotate the carrier 34 in he direction of normal rotation of the engine 22 (step S190), sends the corrected torque commands Tm1* and Tm2* to the motor ECU 40 (step S220) and terminates the dual motor drive control routine.

When it is determined at step S180 that the rotation angle θ reaches the reference value θref, the HVECU 70 determines that there is no need to rotate the carrier 34 any longer. The HVECU 70 accordingly resets the lubrication measure flag F to the value 0 (step 200) and resets the counter C to the value 0 (step S210). The HVECU 70 then sends the torque commands Tm1* and Tm2* of the motors MG1 and MG2 set at step S120 to the motor ECU 40 (step S220) and terminates the routine. This stops rotation of the carrier 34. The carrier 34 is accordingly stopped after rotation by the reference value θref (180 degrees in the embodiment). As described above, the lubricant oil is especially short at the pinion gear 33 of the planetary gear 30 that stops revolution at the upper position. Rotating the carrier 34 by 180 degrees causes the pinion gear that stops revolution at the upper position to be revolved to the lower position, thus reducing a shortage of the lubricant oil supplied to the pinion gears 33.

The hybrid vehicle 20 of the embodiment described above rotates the carrier 34 in the direction of normal rotation of the engine 22, when the counter C becomes equal to or higher than the reference value Cref and the vehicle falls into the predetermined driving force change state during a drive in the dual motor drive mode. This causes the pinion gear 33 of the planetary gear 30 that stops revolution at the upper position to be revolved to the lower position, thus reducing a shortage of the lubricant oil supplied to the pinion gears 33.

The hybrid vehicle 20 of the embodiment, corrects the torque command Tm1* of the motor MG1 to rotate the carrier 34, when the predetermined driving force change state is the state that the accelerator pedal 83 is changed from ON to OFF. The hybrid vehicle 20 of the embodiment maintains the rotation speed Nm1 of the motor MG1 while increasing the rotation speed Nm2 of the motor MG2 to rotate the carrier 34, when the predetermined driving force change state is the state that, the accelerator pedal 83 is depressed by a predetermined amount or more. The hybrid vehicle 20 of the embodiment maintains the rotation speed Nm1 of the motor MG1 while increasing the rotation speed Nm2 of the motor MG2 by inertia, to rotate the carrier 34, when the predetermined driving force change state is the state that the vehicle runs on a downhill in the accelerator-off condition. The hybrid vehicle 20 of the embodiment can thus rotate the carrier 34 according to the vehicle driving force change state.

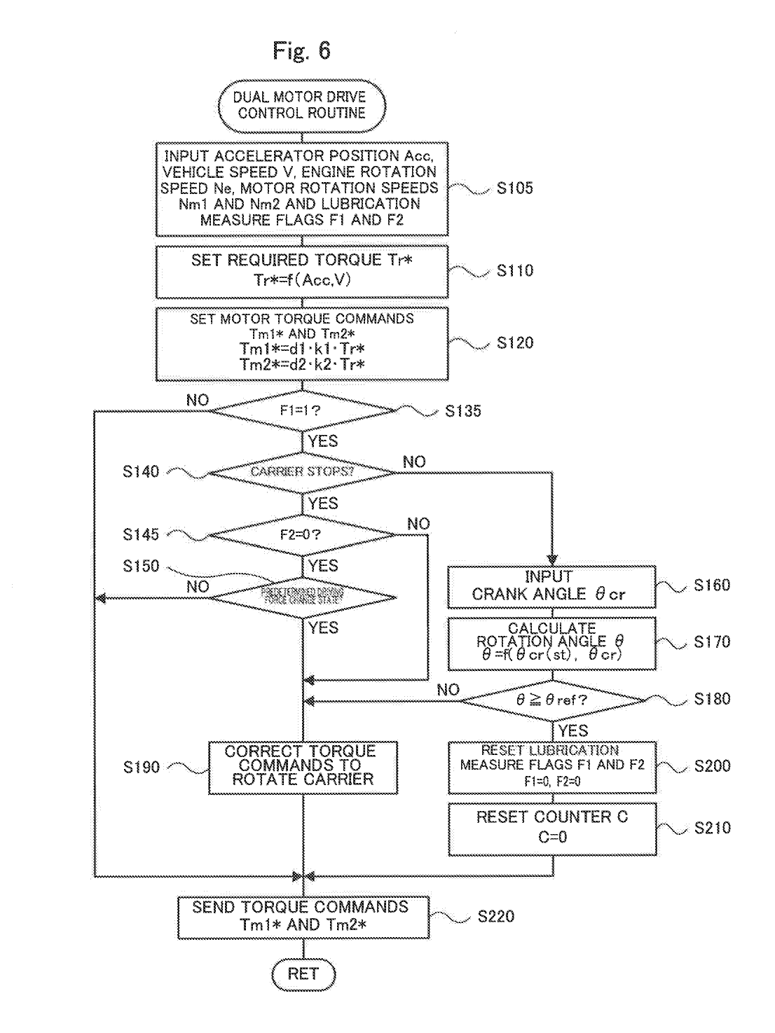

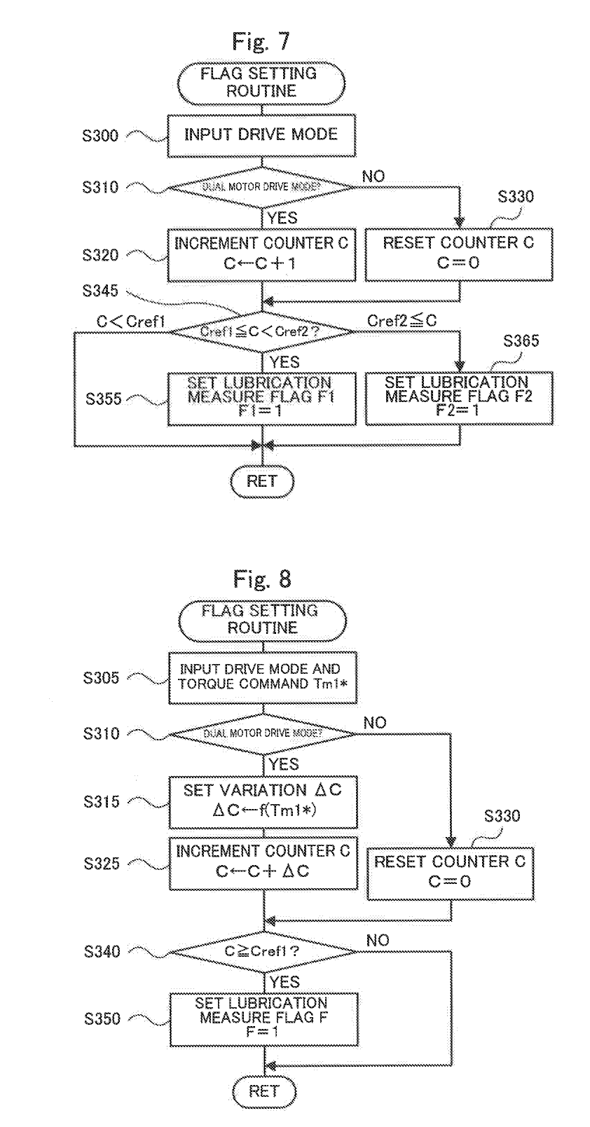

The hybrid vehicle 20 of the embodiment rotates the carrier 34 when the counter C becomes equal to or higher than the reference value Cref1 and the vehicle falls into the predetermined driving force chancre state. A modification may rotate the carrier 34 immediately when the counter C becomes equal to or higher than the reference value Cref1. Another modification may rotate the carrier 34 after elapse of a predetermined time period when the counter C becomes equal to or higher than the reference value Cref1 but the vehicle does not fall into the predetermined driving force change state in the predetermined time period. One example, of the dual motor drive control routine of the latter modification is shown in FIG. 6, and one example of the flag setting routine of this modification is shown in FIG. 7.

In the flag setting routine of FIG. 7, the HVECU 70 inputs the drive mode (step S300) and determines whether the input drive mode is the dual motor drive mode (step S310). When the input drive mode is the dual motor drive mode, the HVECU 70 increments the counter C by adding the value 1 to the counter C (step S320). When the input drive mode is not the dual motor drive mode, on the other hand, the HVECU 70 resets the counter C to the value 0 (step S330). The HVECU 70 subsequently compares the counter C with a reference value Cref1 and a reference value Cref2 (step (S345), When the counter C is lower than the reference value Cref1, the HVECU 70 keeps lubrication measure flags F1 an F2 to value 0 and terminates the flag setting routine, When the counter C is not lower than the reference value Cref1 but is lower than the reference value Cref2, the HVECU 70 sets the lubrication measure flag F1 to value 1 (step S355) and terminates the flag setting routine. When the counter C is not lower than the reference value Cref2, the HVECU 70 sets the lubrication measure flag F2 to value 1 (step S365) and terminates the flag setting routine. In other words, the lubrication measure flag F1 is set to the value 1 when the counter C becomes equal to or higher than the reference value Cref1. The lubrication measure flag F2 is set to the value 1 when the counter C becomes equal to or higher than the reference value Cref2. Like the reference value Cref1 described above in the first embodiment, the reference value Cref1 denotes a threshold value to determine whether a predetermined time period Tref1 has elapsed since a stop of rotation of the carrier 34 and is determined, based on the predetermined time period Tref1 and the interval of execution of this flag setting routine. The reference value Cref2 denotes a threshold value to determine whether a predetermined time period Tref2 longer than the predetermined time period Tref1 has elapsed and is determined, based on the predetermined time period Tref2 and the interval of execution of the flag setting routine. The predetermined time period Tref2 is determined by experiment or by analysis as a time duration required to immediately take a measure against a shortage of the lubricant oil supplied to the pinion gears 33.

In the dual motor drive control routine of FIG. 6, the HVECU 70 first inputs the accelerator position Acc, the vehicle speed V, the engine rotation speed Ne, the motor rotation speeds Nm1 and Nm2 and the lubrication measure flags F1 and F2 (step S105) and sets the required torque Tr* based on the input accelerator position Ace and the input vehicle speed V (step S110). The HVECU 70 sets the torque commands Tm1* and Tm2* of the motors MG1 and MG2 using the required torque Tr*, the torque distribution ratios d1 and d2 and the conversion factors k1 and k2 (step S120). The HVECU 70 subsequently determines whether the lubrication measure flag F1 is equal to the value 1 (step S135). When the lubrication measure flag F1 is the value 0, the HVECU 70 determines that there is no need to take a measure against a shortage of the lubricant oil supplied, to the pinion gears 33, sends the set torque commands Tm1* and Tm2* to the motor ECU 40 (step S220) and terminates the routine.

When it is determined at step S135 that the lubrication measure flag F1 is the value 1, on the other hand, the HVECU 70 determines that there is a need to take a measure against a shortage of the lubricant oil supplied to the pinion gears 33 and subsequently determines whether the carrier 34 stops rotation, i.e., whether the measure is being implemented against a shortage of the lubricant oil supplied, to the pinion gears 33 by rotating the carrier 34 (step S140). When the carrier 34 stops rotation, the HVECU 70 checks the lubrication measure flag F2 (step S145). When, the lubrication measure flag F2 is the value 0, the HVECU 70 determines that there is no need to immediately take a measure against at shortage of the lubricant oil supplied to the pinion gears 33 and subsequently determines whether the vehicle falls into the predetermined driving force change state (step S150). The HVECU 70 then rotates the carrier 34 according to the condition of the driving force change when the vehicle fails into the predetermined driving force change state (step S190 and steps S160 to S210), like the above embodiment.

When the predetermined time period has elapsed without causing the vehicle to fall into the predetermined driving force change state with the lubrication measure flag F1 equal to the value 1 and the lubrication measure flag F2 equal to the value 0, the lubrication measure flag F2 is set to the value 1. It is then determined at step S145 that the lubrication measure flag F2 is the value 1. In this case, the HVECU 70 corrects the torque commands Tm1* and Tm2* of the motors MG1 and MG2 to rotate the carrier 34 in the direction of normal rotation of the engine 22 (step S190) and rotates the carrier 34 (steps S160 to S210) without determining whether the vehicle falls into the predetermined driving force change state. The carrier 34 may be rotated by correcting the torque command Tm1* of the motor MG1 according to the condition of the driving force change of the vehicle or may be rotated by increasing the rotation speed Nm2 of the motor MG2 while maintaining the rotation speed Nm1 of the motor MG1. When there is a need to immediately take a measure against a shortage of the lubricant oil supplied to the pinion gears 33, such control rotates the carrier 34 and thereby revolves the pinion gears 33 around the carrier 34 irrespective of whether the vehicle falls into the predetermined driving force change state, thereby reducing the shortage of the lubricant oil supplied to the pinion gears 33.

The hybrid vehicle 20 of the embodiment increments the counter C one by one and sets the lubrication measure fag F to the value 1 after elapse of the predetermined time period in the dual motor drive mode according to the flag setting routine of FIG. 3. According to a modification, the lubrication measure flag F may be set to the value 1 after elapse of a time period corresponding to the torque applied to the pinion gears 33 in the dual motor drive mode. More specifically, the counter C is incremented by a larger value at the larger torque applied to the pinion gears 33 than a value at the smaller torque applied to the pinion gears 33. A flag setting routine of this modification is shown in FIG. 8. In the flag setting routine of FIG. 8, the HVECU 70 inputs the drive mode and the torque command Tm1* of the motor MG1 (step S305) and determines whether the input drive mode is the dual motor drive mode (step S310). When the input drive mode is not the dual motor drive mode, the HVECU 70 resets the counter C to the value 0 (step S330). When the input drive mode is the dual motor drive mode, on the other hand, the HVECU 70 sets a variation ΔC according to the input torque command Tm1* of the motor MG1 (step S315) and increments the counter C by adding the set variation ΔC to the counter C (step S325). The HVECU 70 subsequently determines whether the counter C is equal to or higher than the reference value Cref1 (step S340). When the counter C is equal to or higher than the reference value Cref1, the HVECU 70 sets the lubrication measure flag F to the value 1 (step S350) and terminates the flag setting routine. The variation ΔC may be set to a larger value according to the larger absolute value of the torque output from the motor MG1, for example, may be set to value 1 when the absolute value of the torque command Tm1* of the motor MG1 is less than a reference value Tref1, set to value 2 when the absolute value of the torque command Tm1* of the motor MG1 is not less than the reference value Tref1 but is less than a reference value Tref2, and set to value 3 when the absolute value of the torque command Tm1* of the motor MG1 is not less than the reference value Tref2. In the dual motor drive mode, the torque applied to the pinion gears 33 is proportional to the torque output from the motor MG1. Incrementing the counter C by the larger variation ΔC according to the larger absolute value of the torque output from the motor MG1 (torque command Tm1*) accordingly means incrementing the counter C by the larger variation ΔC according to the larger torque applied to the pinion gears 33. The larger torque applied to the pinion gears 33 is more likely to cause a problem by the shortage of the lubricant oil supplied to the pinion gears 33. Rotating the carrier 34 after elapse of a shorter time period at the larger torque applied to the pinion gears 33 than a time period at the smaller torque applied to the pinion gears 33 thus more effectively reduces the shortage of the lubricant oil supplied to the pinion gears 33.

According to another modification, the lubrication measure flag F may be set to the value 1 after elapse of a time period corresponding to the rotation speed of the pinion gears 33 in the dual motor drive mode. More specifically, the counter C is incremented by a larger value at the higher rotation speed of the pinion gears 33 than a value at the lower rotation speed of the pinion gears 33. In this modification, the flag setting routine of FIG. 8 may be modified by replacing inputting the torque command Tm1* at step S305 with inputting the rotation speed Nm1 of the motor MG1 and by replacing setting the variation ΔC based on the torque command Tm1* at step S315 with setting the variation ΔC based on the rotation speed Nm1 of the motor MG1. The variation ΔC may be set to a larger value according to the larger absolute value of the rotation speed Nm1 of the motor MG1, for example, may be set to value 1 when the absolute value of the rotation speed Nm1 of the motor MG1 is less than a reference value Nref1, set to value 2 when the absolute value of the rotation speed Nm1 of the motor MG1 is not less than the reference value Nref1 but is less than a reference value Nref2, and set to value 3 when the absolute value of the rotation speed Nm1 of the motor MG1 is not less than the reference value Nref2. In the dual motor drive mode, the rotation speed of the pinion gears 33 is proportional to the. rotation speed Nm1 of the motor MG1. Incrementing the counter C by the larger variation ΔC according to the larger absolute value of the rotation speed Nm1 of the motor MG1 accordingly means incrementing the counter C by the larger variation ΔC according to the higher rotation speed of the pinion gears 33. The higher rotation speed of the pinion gears 33 is more likely to cause a problem by the shortage of the lubricant oil supplied to the pinion gears 33. Rotating the carrier 34 after elapse of a shorter time period at the higher rotation speed of the pinion gears 33 than a time period, at the lower rotation speed of the pinion gears 33 thus more effectively reduces the shortage of the lubricant oil supplied to the pinion gears 33. According to a modification, the counter C may be decremented by the variation ΔC at the lower rotation speed of the pinion gears 33. For example, the variation ΔC may be set to value −1 when the absolute value of the rotation speed Nm1 of the motor MG1 is less than the reference value Nref1, set to value 0 when the absolute value of the rotation speed Nm1 of the motor MG1 is not less than the reference value Nref1 but is less than the reference value Nref2, and set to value 1 when the absolute value of the rotation speed Nm1 of the motor MG1 is not less than the reference value Nref2.

According to another modification, the lubrication measure flag F may be set to the value 1 after elapse of a time period corresponding to the temperature of the lubricant oil in the planetary gear 30 in the dual motor drive mode. More specifically, the counter C is incremented, by a larger value at the higher temperature of the lubricant oil in the planetary gear 30 than, a value at the lower rotation speed of the lubricant, oil. In this modification, the flag setting routine of FIG. 8 may be modified by replacing inputting the torque command Tm1* at step S305 with inputting the temperature of the lubricant oil and by replacing setting the variation ΔC based on the torque command Tm1* at step S315 with setting the variation ΔC based on the temperature of the lubricant oil. The variation ΔC may be set to a larger value according to the higher temperature of the lubricant, oil, for example, may be set to value 1 when the temperature of the lubricant oil is lower than a reference value T1, set to value 2 when the temperature of the lubricant oil is not lower than the reference value T1 but is lower than a reference value T2 and set to value 3 when, the temperature of the lubricant oil is not lower than the reference value T2. The higher temperature of the lubricant oil in the planetary gear 30 provides the lower viscosity of the lubricant oil, compared with the lower temperature of the lubricant oil. This makes the lubricant oil at the pinion gear 33 that stops rotation at the upper position in the planetary gear 30 more likely to flow down. Rotating the carrier 34 after elapse of a shorter time period at the higher temperature of the lubricant oil in the planetary gear 30 than a time period at the lower temperature of the lubricant oil thus more effectively reduces the shortage of the lubricant oil supplied to the pinion gears 33.

According to another modification, the lubrication measure flag F may be set to the value 1 after elapse of a time period corresponding to the state of charge SOC of the battery 50 in the dual motor drive mode. More specifically, the counter C is incremented by a larger value, at the larger reduction in the state of charge SOC of the battery 50 than a value at the smaller reduction in the state of charge SOC. In this modification, the flag setting routine of FIG. 8 maybe modified by replacing inputting the torque command Tm1* at step S305 with inputting the state of charge SOC of the battery 50 and by replacing setting the variation ΔC based on the torque command Tm1* at step S315 with setting the variation ΔC based on a reduction in the state of charge SOC of the battery 50. The variation ΔC may be set to a larger value according to the larger reduction in the state of charge SOC, for example, may be set. to value 1 when the reduction in the state of charge SOC is less than a reference value S1, set to value 2 when the reduction in the state of charge SOC is not less than the reference value S1 but is less than a reference value S2, and set to value 3 when the reduction in the state of charge SOC is not less than the reference value S2. In the dual motor drive mode, the electric power from the battery 50 is consumed by both the motor MG1 and the motor MG2. The larger reduction in the state of charge SOC of the battery 50 accordingly provides the larger absolute value of the torque output from the motor MG1 and the larger absolute value of the rotation speed Nm1 of the motor MG1, compared with the smaller reduction in the state of charge SOC of the battery 50. The torque applied to the pinion gears 33 and the rotation speed of the pinion gears 33 are proportional to the torque output from the motor MG1 and the rotation speed Nm1 of the motor MG1, Incrementing the counter C by the larger variation ΔC according to the larger reduction in the state of charge SOC of the battery 50 accordingly means incrementing the counter C by the larger variation ΔC according to the larger torque applied to the pinion gears 33 and the higher rotation speed of the pinion gears 33. The larger torque applied to the pinion gears 33 and the higher rotation speed of the pinion gears 33 are more likely to cause a problem by the shortage of the lubricant oil supplied to the pinion gears 33. Rotating the carrier 34 after elapse of a shorter time period at the larger reduction in the state of charge SOC of the battery 50 than a time period at the smaller reduction in the state of charge SOC thus more effectively reduces the shortage of the lubricant, oil supplied to the pinion gears 33.

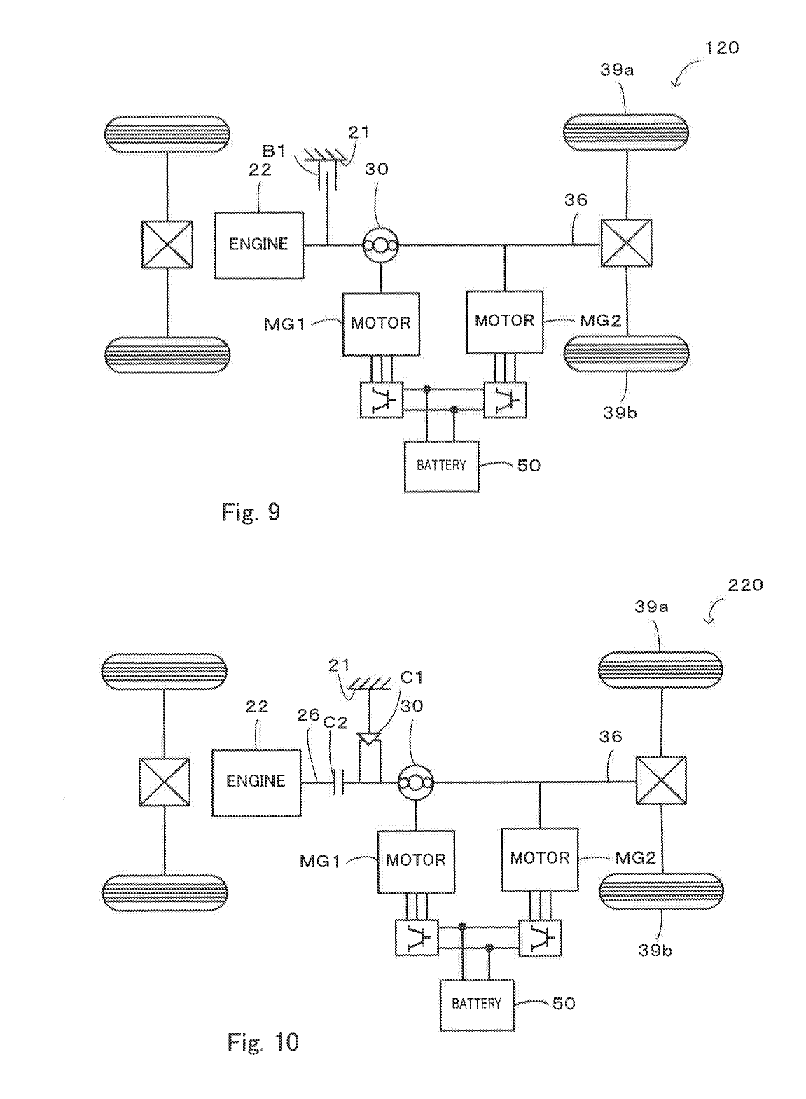

In the hybrid vehicle 20 of the above embodiment, the one-way clutch C1 is attached to the carrier 34. Like a hybrid vehicle 120 of a modification shown in FIG. 9, however, a brake B1 may be attached to the carrier 34. The brake B1 is configured to fix (connect) the carrier 34 to be non-rotatable relative to the casing 21 and to release the carrier 34 to be rotatable relative to the casing 21. In this modified configuration, the hybrid vehicle 120 runs in the dual motor drive mode basically with setting the brake 331 ON to fix the carrier 34. In the dual motor drive control routine of FIG. 2, the brake B1 may be set OFF immediately before step S190 to allow for rotation of the carrier 34, and the brake B1 may be set ON immediately after step S210 to stop rotation of the carrier 34. In this modified configuration, when the engine 22 is allowed to be rotated in a reverse direction, the rotating direction of the carrier 34 may be the direction of normal rotation of the engine 22 or may be the direction of reverse rotation of the engine 22.

In the hybrid vehicle 20 of the embodiment, the crankshaft 26 of the engine 22 is connected with the carrier 34 via the damper 28. Like a hybrid vehicle 220 of a modification shown in FIG. 10, however, the crankshaft 26 may be connected with the carrier 34 via a clutch C2 and a damper (not shown). In this modified configuration, the hybrid vehicle 220 runs in the dual motor drive mode with setting the clutch C2 ON to connect the carrier 34 with the crankshaft 26. In the dual motor drive control routine of FIG. 2, the clutch C2 may be set OFF immediately before step S190 to allow for rotation of the carrier 34, and the clutch C2 may be set ON immediately after step S210 to stop rotation of the carrier 34. This eliminates the need to rotate the crankshaft 26 of the engine 22 and can thus rotate the carrier 34 and revolve the pinion gears 33 around the carrier 34 with a little energy.

In the hybrid vehicle of the invention, the predetermined condition may be a condition that a predetermined time period has elapsed. This causes the carrier to be rotated at every predetermined time period and, reduces the shortage of the lubricant oil supplied to the pinion gears.

In the hybrid vehicle of the invention, the predetermined condition may be a condition that a state of an accelerator is changed from accelerator-on to accelerator-off after elapse of a predetermined time, period or a condition that an operating amount of the accelerator is changed by a predetermined amount or more after elapse of a predetermined time period. Rotating the carrier is likely to vary the driving force. When the carrier is rotated in the state of a change from accelerator-on to accelerator-off that varies the driving force or in the state of a change in operating amount of the accelerator by the predetermined amount or more that varies the driving force, the variation in, the driving force by rotation of the carrier is made less noticeable. As a result, this suppresses the driver and the passengers from feeling strange by the variation in the driving force, by rotation of the carrier.

In the hybrid vehicle of the invention, the predetermined condition may be a condition that a time period according to a torque applied to the pinion gears has elapsed or may be a condition that a time period according to a temperature of lubricant oil in the planetary gear mechanism has elapsed. The condition that the time period according to the torque applied to the pinion gears has elapsed may be, for example, a condition that a shorter time period has elapsed at the larger torque applied to the pinion gears than a time period at the smaller applied torque. The larger torque applied to the pinion gears needs the more lubricant oil. Using the condition that a shorter time period has elapsed at the larger torque applied to the pinion gears than a time period at the smaller applied torque thus more effectively reduces the shortage of the lubricant oil supplied to the pinion gears. The torque applied to the pinion gears is related to the torque output, from the first motor. The “condition that, the time period according to the torque applied to the pinion gears has elapsed” is thus synchronous with a “condition that a time period according to the torque output from the first motor has elapsed” . The condition that the time period according to the temperature of the lubricant oil in the planetary gear mechanism has elapsed may be, for example, a condition that a shorter time period has elapsed at the higher temperature of the lubricant oil than a time period at the lower temperature of the lubricant oil. The higher temperature of the lubricant oil provides the lower viscosity of the lubricant oil, compared with the lower temperature of the lubricant oil. The lubricant oil at the pinion gear that stops revolution at the upper position in the planetary gear mechanism is more likely to flow down. Using the condition that a shorter time period has elapsed at the higher temperature of the lubricant oil than, a time period at the lower temperature of the lubricant oil thus more effectively reduces the shortage of the lubricant oil supplied to the pinion gears.

In the hybrid vehicle of the invention, the predetermined, rotation control maybe a control of rotating the carrier by changing a rotation speed of the first motor and/or by changing a rotation speed of the second motor while maintaining the rotation speed of the first motor. Rotating the carrier by changing the rotation speed of the first motor requires only control of the first motor. Rotating the carrier by changing the rotation speed of the second motor while maintaining the rotation speed of the first motor, on the other hand, enables the carrier to be rotated with an increase in vehicle speed.

In the hybrid vehicle of the invention, the predetermined rotation control maybe a control of rotating the carrier by changing a rotation speed of the first motor when a state of an accelerator is changed from accelerator-on to accelerator-off. In the accelerator-off state, it is often the case that the torque of the first motor is set to value 0 and a slight deceleration force according to the vehicle speed is output from the second motor. The carrier can thus be rotated by changing the rotation of the first motor. In this case, it is preferable to rotate the carrier in the direction of normal rotation of the engine.

In the hybrid vehicle of the invention, the

predetermined rotation control may be a control of rotating the carrier by changing a rotation speed of the second motor while maintaining a rotation speed of the first motor when an operating amount of an accelerator is increased by a predetermined amount or more. In the state of acceleration that increases the operating amount of the accelerator by a predetermined amount or more, the vehicle speed is more likely to increase. The carrier can thus be rotated with an increase in vehicle speed by changing the rotation, speed of the second motor while maintaining the rotation speed of the first motor. In this case, it is preferable to rotate the carrier in the direction of normal rotation of the engine.

In the hybrid vehicle of the invention, the predetermined rotation control may be a control of rotating the carrier by changing a rotation speed of the second motor while maintaining a rotation speed of the first motor when the hybrid vehicle runs on a downhill in an accelerator-off condition. The carrier can thus be rotated by using a force of increasing the vehicle by inertia on the downhill. In this case, the carrier is rotated in the direction of normal rotation of the engine.

The hybrid vehicle of the invention may further include a clutch that is configured to connect and disconnect the output shaft of the engine with and from the carrier. The controller may perform the predetermined rotation control in a state that the clutch disconnects the output shaft of the engine from the carrier. This eliminates the need to rotate the output shaft of the engine and can thus rotate the carrier with a small power. In this case, the carrier may be rotated in the direction of normal rotation of the engine or may e rotated in the direction of reverse rotation of the engine.

The following describes the correspondence relationship between the primary components of the embodiments and the primary components of the invention described in Summary of Invention. The engine 22 of the embodiment corresponds to the “engine”; the motor MG1 corresponds to the “first motor”; the planetary gear 30 corresponds to the “planetary gear mechanism”; the motor MG2 corresponds to the “second motor”; the battery corresponds to the “battery” ; and the one-way clutch C1 corresponds to the “rotation control mechanism”. The combination of the engine ECU 24, the motor ECU 40 and the HVECU 70 corresponds to the “controller”.

The correspondence relationship between the primary components of the embodiment and the primary components of the invention, regarding which the problem is described in Summary of Invention, should not be considered to limit the components of the invention, regarding which the problem is described in Summary of Invention, since the embodiment is only illustrative to specifically describes the aspects of the invention, regarding which the problem is described in Summary of Invention. In other words, the invention, regarding which the problem is described in Summary of Invention, should be interpreted on the basis of the description in the Summary of Invention, and the embodiment is only a specific example of the invention, regarding which the problem is described in Summary of Invention.

The embodiment discussed above is to be considered in all aspects as illustrative and not restrictive. There maybe many modifications, changes, and alterations without departing from the scope or spirit of the main characteristics of the present invention. The scope and spirit of the present invention are indicated by the appended claims, rather than by the foregoing description.

### INDUSTRIAL APPLICABILITY

The present invention is applicable to, for example, manufacturing industries of hybrid vehicles.

1. A hybrid vehicle, comprising: an engine;
a first motor that is configured to generate electric power;
a planetary gear mechanism having a sun gear, a ring gear, a plurality of pinion gears that engage with the sun gear and with the ring gear, and a carrier that is linked with the plurality of pinion gears, wherein the sun gear, the ring gear and the carrier are respectively connected in this sequence with, a rotating shaft of the first motor, a driveshaft linked with, an axle and an output shaft of the engine;
a second motor that, is configured to generate electric power and is mounted to the driveshaft;
a battery that is configured to transmit electric power to and from the first motor and the second motor;
a rotation control mechanism that, is configured to control rotation of the carrier; and
a controller that is configured to control the engine, the first, motor and the second motor such as to cause the hybrid vehicle to be driven in one of a plurality of drive modes, wherein the plurality of drive modes include a dual motor drive mode that causes the hybrid vehicle to be driven with powers from the first motor and the second motor with stopping rotation of the carrier and a hybrid drive mode that causes the hybrid vehicle to be driven with powers from the engine, the first motor and the second motor with rotating the carrier, wherein
after a stop of rotation of the carrier during a drive of the hybrid vehicle in the dual motor drive mode, when a predetermined condition including a time elapsed since the stop of rotation is satisfied, the controller performs a predetermined rotation control that controls the carrier to rotate.

2. The hybrid vehicle according to claim 1,
wherein the predetermined rotation control is a control of rotating the carrier by a rotation angle of any of 180 degrees, 120 degrees and 90 degrees.

3. The hybrid vehicle according to claim 1,
wherein the predetermined condition is a condition that a predetermined time period has elapsed.

4. The hybrid vehicle according to claim 1,
wherein the predetermined condition is a condition that a state of an accelerator is changed from, accelerator-on to accelerator-off after elapse of a predetermined time period or a condition that an operating amount of the accelerator is changed by a predetermined amount or more after elapse of a predetermined time period.

5. The hybrid vehicle according to claim 1,
wherein the predetermined condition is a condition that a time period according to a torque applied to the pinion gears has elapsed or a condition that a time period according to a temperature of lubricant oil in the planetary gear mechanism has elapsed.

6. The hybrid vehicle according to claim 1,
wherein the predetermined rotation control is a control of rotating the carrier by changing a rotation speed of the first motor and/or by changing a rotation speed of the second motor while maintaining the rotation speed of the first motor.

7. The hybrid vehicle according to claim 1,
wherein the predetermined rotation control is a control of rotating the carrier by changing a rotation speed of the first motor when a state of an accelerator is changed from accelerator-on to accelerator-off.

8. The hybrid vehicle according to claim 1,
wherein the predetermined rotation control is a control of rotating the carrier by changing a rotation speed of the second motor while maintaining a rotation speed of the first motor when an operating amount of an accelerator is increased by a predetermined amount or more.

9. The hybrid vehicle according to claim 1,
wherein the predetermined rotation control is a control of rotating the carrier by changing a rotation speed of the second motor while maintaining a rotation speed of the first motor when the hybrid vehicle runs on a downhill in an accelerator-off condition.

10. The hybrid vehicle according to claim further comprising:
a clutch that is configured to connect and disconnect the output shaft of the engine with and from the carrier, wherein
the controller performs the predetermined rotation control in a state that the clutch disconnects the output shaft of the engine from the carrier.
